(19) United States
(12) Patent Application Publication
(10) Pub. No.: US 2025/0280889 A1
(43) Pub. Date: Sep. 11, 2025

(54) AEROSOL PROVISION DEVICE

(71) Applicant: NICOVENTURES TRADING LIMITED, London (GB)

(72) Inventor: Sean LUKAN, Winston-Salem, NC (US)

(21) Appl. No.: 18/858,940

(22) PCT Filed: Apr. 21, 2023
(86) PCT No.: PCT/GB2023/051059

§ 371 Date: Oct. 22, 2024

(30) Foreign Application Priority Data
Apr. 22, 2022 (GB) 2205853.1

(51) Int. Cl. A24F 40/49; A24F 40/53; A24F 40/65; G06F 21/32

(52) U.S. Cl. CPC A24F 40/49; A24F 40/53; A24F 40/65; G06F 21/32

(57) ABSTRACT

There is provided an aerosol provision device for providing an aerosol for inhalation by a user comprising: control circuitry for controlling components of the aerosol provision device; a sound sensor arranged to sense a sound associated with a user of the aerosol provision device and provide a signal to the control circuitry; a signal emitter arranged to emit a signal; and, age verification means for verifying an age of a user, wherein the control circuitry is arranged to i) change an activation state of the signal emitter or ii) or activate the age verification means in response to receiving a signal originating from the sound sensor.

### TECHNICAL FIELD

The present invention relates to an aerosol provision device, an aerosol provision system, a method of providing an aerosol for inhalation by a user, and aerosol-generating means.

### BACKGROUND

Aerosol-generating systems are known. Common systems use heaters which are activated by a user to create an aerosol by an aerosol provision device from an aerosol generating material which is then inhaled by the user. The device may be activated by a user at the push of a button or merely by the act of inhalation. Modern systems can use consumable elements containing the aerosol generating material. It can be desirable for the manufacturer to enable control over the activation of the systems. This may avoid the activation of the system in undesirable circumstances.

The present invention is directed toward solving some of the above problems.

### SUMMARY

Aspects of the invention are defined in the accompanying claims.

In accordance with some embodiments described herein, there is provided an aerosol provision device for providing an aerosol for inhalation by a user comprising: control circuitry for controlling components of the aerosol provision device; a sound sensor arranged to sense a sound associated with a user of the aerosol provision device and provide a signal to the control circuitry; a signal emitter arranged to emit a signal; and, age verification means for verifying an age of a user, wherein the control circuitry is arranged to i) change an activation state of the signal emitter or ii) or activate the age verification means in response to receiving a signal originating from the sound sensor.

Such a device is able to identify a potential user of the device via a sound signal. The device is able to interpret the sound signal from the user and ascertain whether the user is a recognised authorised user of the device. Following receipt of the sound signal, the device can change an activation state of the signal emitter, or activate the age verification means. In this way, the device can provide a noise (if e.g. the user is a recognised authorised user of the device) or provide an age verification option to the unrecognised user. If the user is of a suitable age to use the device, the control circuitry may then update the activation state of the device to an operating state and the user may initiate use of the device. Initiating use of the device may be via an inhalation or pressing a button or the like. The age verified user's voice may then be added to a database of valid users.

This allows the device to determine if age verification is required (as a result of the sound signal from the potential user) and then perform age verification if it is. This provides an increased in-use safety aspect for the device while avoiding unnecessary interference in circumstances that do not require age verification (such as for recognised users). This therefore strikes a balance between overly strict and overly lenient control over the usage of the aerosol provision device.

In particular, in the event that user 1 wishes to use the aerosol provision device, user 1 provides a sound signal for recognition by the sound sensor. The sound sensor senses the sound and provides a signal to the control circuitry that can compare the sound against a known list of sounds of authorised users (or known recognition words or the like). If user 1 makes a sound recognised by the control circuitry, the control circuitry allows user 1 to use the device. If the sound is not recognised, the control circuitry can request age verification is performed to confirm the user is of an appropriate age to use the device.

The aerosol provision system of the present invention is able to operate in “offline” or “online” mode when performing age verification of potential users. In this way, a valid user may operate the system in offline (unconnected to a mobile network or internet or the like) environment provided the user satisfies the criteria for operation. The user experience of the device is thereby improved. This can be achieved by including a memory in the aerosol provision system with which at least one of the sound sensor and the age verification means communicates.

In accordance with some embodiments described herein, there is provided an aerosol provision system for providing an aerosol for inhalation by a user comprising: an aerosol provision device comprising control circuitry for controlling components of the aerosol provision device; a sound sensor arranged to sense a sound associated with a user of the aerosol provision device and provide a signal to the control circuitry; a signal emitter arranged to emit a signal; and, age verification means for verifying an age of a user, wherein the control circuitry is arranged to i) change an activation state of the signal emitter or ii) or activate the age verification means in response to receiving a signal originating from the sound sensor.

In accordance with some embodiments described herein, there is provided a method of providing an aerosol for inhalation by a user, the method comprising: sensing, by a sound sensor, a sound associated with a user of an aerosol provision device; providing, by the sound sensor, a signal to control circuitry of the aerosol provision device; in response to receiving a signal originating from the sound sensor, performing at least one of: changing, by the control circuitry, an activation state of a signal emitter; and, activating, by the control circuitry, age verification means.

In accordance with some embodiments described herein, there is provided aerosol provision means for providing an aerosol for inhalation by a user comprising: control means for controlling components of the aerosol provision device; sound sensing means arranged to sense a sound associated with a user of the aerosol provision means and provide a signal to the control means; signal emitting means arranged to emit a signal; and, age verification means for verifying an age of a user, wherein the control means is arranged to i) change an activation state of the signal emitting means or ii) or activate the age verification means in response to receiving a signal from the sound sensing means.

### DESCRIPTION OF DRAWINGS

The present teachings will now be described by way of example only with reference to the following figures:

FIG. 1 is a schematic view of an aerosol provision system according to an example;

FIG. 2 is a schematic view of an aerosol provision system according to an example;

FIG. 3 is a schematic view of an aerosol provision system according to an example; and,

FIG. 4 is a schematic view of an aerosol provision system according to an example.

While the invention is susceptible to various modifications and alternative forms, specific embodiments are shown by way of example in the drawings and are herein described in detail. It should be understood, however, that the drawings and detailed description of the specific embodiments are not intended to limit the invention to the particular forms disclosed. On the contrary, the invention covers all modifications, equivalents and alternatives falling within the scope of the present invention as defined by the appended claims.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to aerosol provision systems, which may also be referred to as aerosol provision systems, such as e-cigarettes. Throughout the following description the term “e-cigarette” or “electronic cigarette” may sometimes be used, but it will be appreciated this term may be used interchangeably with aerosol provision system/device and electronic aerosol provision system/device. Furthermore, and as is common in the technical field, the terms “aerosol” and “vapour”, and related terms such as “vaporise”, “volatilise” and “aerosolise”, may generally be used interchangeably.

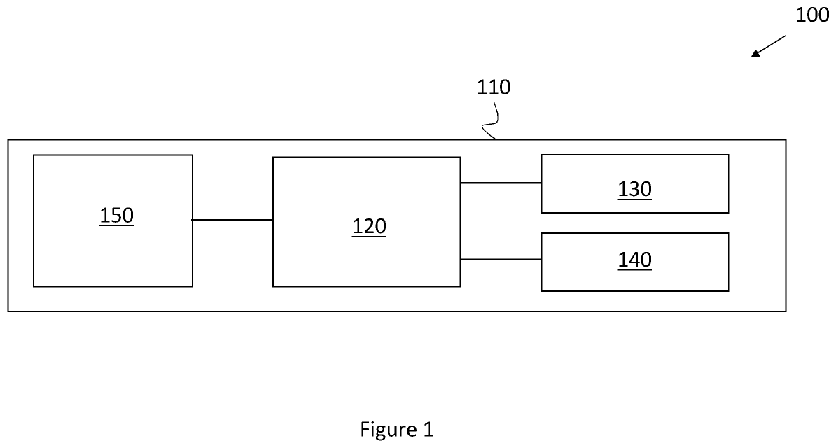

FIG. 1 illustrates a schematic view of an example of an aerosol provision device 100 according to the present invention. The aerosol provision device 100 comprises an aerosol provision device housing 110. The aerosol provision device 100 has control circuitry 120. The control circuitry 120 is arranged to control components of the aerosol provision device 100. The aerosol provision device 100 comprises a sound sensor 130 arranged to sense a sound associated with a user of the aerosol provision device 100 and provide a signal to the control circuitry 120. The aerosol provision device 100 further comprises a signal emitter 140 arranged to emit a signal. The aerosol provision device 100 further comprises age verification means 150 for verifying an age of a user. The control circuitry 120 is arranged to change an activation state of the signal emitter 140 or activate the age verification means 150 in response to receiving a signal originating from the sound sensor 130.

In an example, the sound sensor 130 detects a sound associated with a user of the aerosol provision device 100. The sound may be a password or the like that can be compared against a database of known or active passwords. The sound instead may be any word and the aerosol provision device 100 operates on recognition of the user's voice. The sound or word is compared against known allowable user's voices or against known allowable passwords. If the sound is recognised, the control circuitry 120 may change an activation state of the signal emitter, such that the signal emitter emits a sound. This allows a valid user to make a sound and the emitter 140 indicate the location of the aerosol provision device 100. If the sound is not recognised, the emitter 140 may not be activated. In this event, the control circuitry 120 may activate instead the age verification means 150 of the device 100. This allows users that are of a suitable age to pass age verification and then use the device 100. This also offers a suitable fallback in the instance that an authorised user forgets the password used to activate the device 100.

In an example, the control circuitry 120 is arranged to change an activation state of the signal emitter 140 in response to receipt of a signal from the sound sensor 130 associated with an authorised user.

The present arrangement, therefore provides the user with an ability to find a lost aerosol provision device 100 via a “call-and-response” arrangement. This is available to an authorised user, such as one with a voice pre-programmed to be recognised by the device 100 or a user knowing a password to the device 100 that can be recognised.

In an example, the control circuitry 120 is arranged to activate the age verification means 150 in response to receipt of a signal from the sound sensor 130 associated with a non-authorised user.

The unverified (or non-authorised) user will not be provided with an indication of the location of the device 100 until age verification is satisfied. While use of the age verification means is difficult while the device 100 is “lost” and the “call-and-response” arrangement is not available, this prioritises prevention of use of the device 100 by unauthorised users. The present arrangement prioritises safety of the device over accessibility.

Once the device 100 is in hand, a user can satisfy age verification via the age verification means 150 and then operate the device 100 as usual, or can program the device 100 to recognise that user's voice for future use. This allows flexibility in the number of users that can be recognised. Furthermore, the device 100 may recognise one user from another via the vocal signals or by having specific passwords for specific users. This provides further flexibility in use of the device 100.

Recognition of the user may be used to allow the device 100 to provide a bespoke heating profile based on the recognised user. If user 1 is recognised by the sound sensor 130 and control circuitry 120, the device 100 can be pre-programmed to associate the user 1 with heating profile 1, at which point the device 100 can provide bespoke aerosol on a per-user basis. User 2 may be provided with heating profile 2, in response to vocal recognition by the device 100.

The signal emitter 140 may be at least one of: a light emitter; a sound emitter; a haptic element; and, an emitter module arranged to use at least one of Bluetooth™, Bluetooth Low Energy™, ZigBee™, WiFi™, Wifi Direct™, GSM, 2G, 3G, 4G, 5G, LTE, NFC, or RFID. In this way, the signal emitter 140 may provide a signal to the user in a number of different manners. The signal emitter 140 may be linked to a smart device or the like to provide the user with an indication of where the device 100 is. Alternatively, the device 100 may provide a beeping or buzzing to enable the user to locate the device 100. More than one of these can provide a broad applicability to a user. When the user is in the same room as the device 100 but is unable to locate it, a beeping is more useful than say an indication on a map. However, if the device 100 has been moved significantly from where the user is located, say if the device 100 has been left at a friend's house or at the office at work, an indication via a smart device of where the device is on a post code level of resolution would be more useful than a beeping. As such, combining these signal emitters provides a better utility for the user.

In an example, the age verification means 150 comprises at least one of: a face scanner; a projector scanner; a microphone; a fingerprint scanner; an iris scanner; and, a communication module for communicating with at least one of: a remote database; a remote computing arrangement; an onboard database; and, an onboard computing arrangement. Each of these provides a suitable manner in which to provide age verification or recognition of a potential user.

In the example of a face scanner (or camera or the like), the age verification means 150 may factor in aspects such as lines in the face, bags under the eyes, and prevalence of e.g. in males, facial hair to provide an age verification means. Such factors can be used to indicate a probable age range of the potential user of the device 100. The age verification means 150 may perform an analysis of the data taken of the user, and provide a signal to the control circuitry 120 indicating whether the user is of a likely suitable or likely unsuitable age for use of the device. Alternatively or additionally, the camera may be used to inspect a users identification, such as a passport to the like, to detect an age of the user. If there is an image on the identification, this can be compared against the user's face using the camera.

In an example, the age verification means 150 receives signals from the control circuitry 120 to provide age verification on the potential user and provides a notification to the user to perform age verification. The age verification means 150 obtains a signal from the user and may process this in a number of ways. The age verification means 150 may pass the signal to the control circuitry 120 for analysis or may analyse the signal directly.

In the example where the age verification means 150 processes the signal directly, the age verification 150 may contain a database e.g. stored in a memory on board the device 100. The signal from the age verification means 150 is compared to signals on the on board database. If the signal is associated with a user of suitable age, the device 100 is updated into an operational state.

This on board database arrangement may be advantageous as the device 100 need not have a communications element in the device 100 to communicate with a remotely held database, and the device 100 need not be connected to a communications network to access a remotely held database prior to each use session. This may allow use of the device 100 in areas without connectivity. This may also provide a faster response than via communicating with a remote database.

In a different example, the database of user age is held remotely, and the age verification means 150 has a communication module to contact the database. The communication module may contact the database with a request for confirming user age. The communication module, and therefore the age estimation module 150, is then provided with an age of the potential user, which is relayed to the control circuitry 120.

This arrangement may be advantageous as the device 100 need not include a memory element for carrying the database and the database can be remotely updated ensuring the device 100 need not have the on board database regularly updated. In this way up-to-date age data can be provided to any relevant devices 100 as soon as the data is uploaded to the central database. In this way, all users can be provided with the updates without each needing to update their own device 100. The remote database may be a governmental database or the like for linking a property of a user to a known age for that user, or for verifying the identification of a user where the identification contains an indication of age for that user.

The age verification means 150 may be able to communicate with an artificial intelligence computing arrangement to verify a user's age. This may be additional to, or alternatively to, the above options for verifying a user's age.

Once a user is age verified, the device 100 may store a sample of the user's voice or a user-selected password for future use with the device 100. This allows a valid user to then utilise the “call-and-response” feature of the device 100.

If a user is not verified, and fails age verification, the age verification means 150 may send a deny signal to the control circuitry 120 to prevent activation of the device 100. This may place the device 100 in a locked state, where an authorised user's password is required to subsequently activate the device 100.

As mentioned above, the sound sensor 130 is arranged to provide a signal to the control circuitry 120 associated with an authorised user in response to detection of at least one of a predetermined vocal pattern (i.e. a password or the like) and an authorised user's voice. Both of these provide an increased ease of use of the device over, e.g., traditional keypad style unlock mechanisms. This increases user experience of the device and increases user engagement with the proposed arrangement.

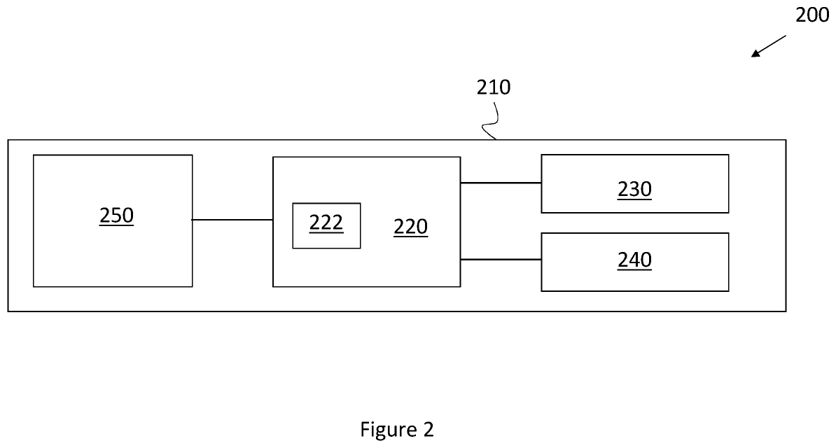

Referring now to FIG. 2, there is a shown a similar device 200 to the device 100 of FIG. 1. Similar features, to those features used in FIG. 1, are shown with the reference numerals increased by 100. For example, the device 100 of FIG. 1 is similar to the device 200 of FIG. 2. Similar or identical features may not be discussed for conciseness.

The device 200 of FIG. 2 has aerosol provision device housing 210 comprising the control circuitry 220, sound sensor 230, signal emitter 240 and age verification means 250. The device 200 also has an on board memory 222. The on board memory 222 is contained within the control circuitry 220 and can store a database of passwords or users' voices for recognition prior to use of the device 200. The on board memory 222 need not be part of the control circuitry 220 but in this specific example, the memory 222 is stored in the control circuitry 220. Signals from the sound sensor 230 and the age verification means 250 may be compared against data in the on board memory 222. Verification and access may occur via comparison of obtained signals to the data in the on board memory 222.

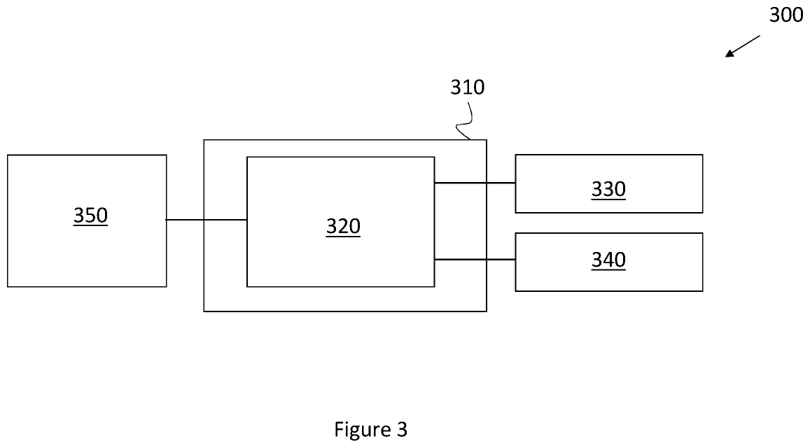

Referring now to FIG. 3, there is a shown a similar system 300 to the device 200 of FIG. 2. Similar features, to those features used in FIG. 2, are shown with the reference numerals increased by 200. For example, the device 200 of FIG. 2 is similar to the system 300 of FIG. 3. Similar or identical features may not be discussed for conciseness.

The system 300 of FIG. 3 has aerosol provision device 310 comprising control circuitry 320. The system 300 also comprises a sound sensor 330, signal emitter 340 and age verification means 350. The system 300 contains the various elements of the device 100 from FIG. 1, however the elements are not necessarily integral with the device 310 of FIG. 3.

In an example, the aerosol provision device 310 can be more easily manufactured if elements such as the age verification means 350 are not integral with the device 310. Furthermore, the age verification means 350 being separate from the aerosol provision device 310 allows the system 300 to take advantage of other elements that can be accessed by a user. For example, the user's smart device may operate as an age verification means 350. In the event that the user's sound signal is not recognised by the device 310, a communication element on the device 310 (for example, as part of the control circuitry 320) may communicate with the smart device and indicate that age verification is to occur. This may occur via a “Monzo”-style verification method. Such verification may occur using multiple authentication methods such as obtaining an image of a photographic identification document (e.g. passport or drivers licence or the like), and following this with obtaining a live video of the owner of said identification document. The video may involve the owner speaking a pre-requested phrase which may be unique to that individual, to further increase the difficulty of fraudulently satisfying the verification. The verification may utilise identity proofing, to assess claimed user identity against actual user identity. The photographic identification document contains an indication of age of the user. Multiple factor authentication is preferable to increase the reliability and safety of the system. Once this authentication is satisfied and the user is deemed of an appropriate identity, the user's identity may be stored suitably to enable future use of the device 100.

This arrangement allows suitable handling of a device that is used by multiple users of different age. The users of suitable age are allowed to access suitable operational states for aerosol generating materials, while users of un-suitable age are prevented from doing so. This ensures that suitability of use is prioritised alongside user safety.

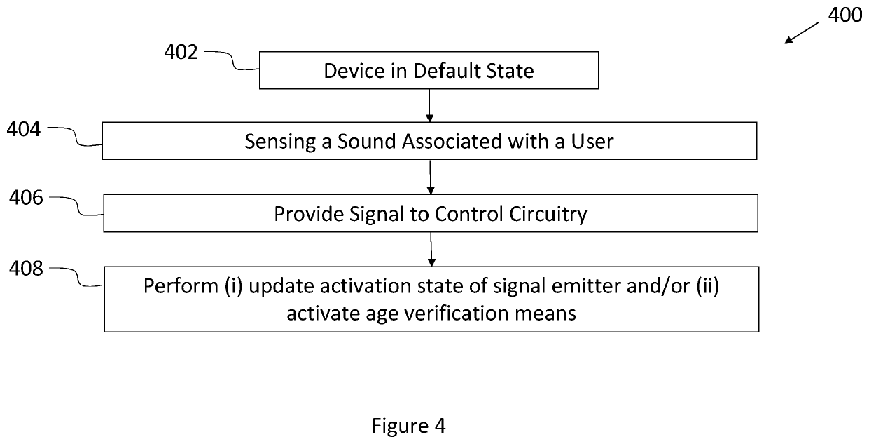

FIG. 4 shows a method 400 of use of an aerosol provision device. In the method 400, the device may start in a default state 402, which may be a non-operating state such that the device cannot be used without vocal recognition of a user or without age verification of the user.

The user then provides a sound for recognition by the device. This may be a sample of the user's voice, a specific sound or a specific word as explained above. This is sensed by the device 404. A signal is then provided accordingly to the control circuitry 406. The control circuitry then performs update of an activation state of the signal emitter (e.g. to emitting a signal) or activates age verification means 408. This outcome is based on whether the sound sensed is recognised or not.

This method provides a user-friendly access and location process that does not impede overly use for authorised users. The method offers a balance between overly strict and overly lenient access protection for the device.

The emitter may indicate the location of the device to the user for further use, in a “call-and-response” arrangement. Alternatively, the user may need to satisfy age verification prior to utilising this function.

The method and device disclosed herein enable use of features of the device without requiring an arduous authorisation process—the process is only as arduous as is required considering the verification level of the user. This improves the user experience of the device and the safety of general use of the device.

The devices and systems disclosed herein have a sound sensor and age verification means that obtain data from a potential user of the aerosol provision device or aerosol provision system. This data may be processed by a number of components able to compare the data against a database (for example) of authorised users and associated sound profiles or the like. This data may be analysed on-board the device by e.g. control circuitry. The control circuitry may analyse the sound signal and evaluate whether to activate the age verification means or the sound emitter.

In an example, the data from the sound sensor may be sent to a remote database or server for analysis. In an example, the device or system may have a communications module for communicating with the remote database or server. The signals from sound sensor may be sent to the communications module. The communications module may, in response, provide a signal to the remote database or server. The remote database or server may then perform the analysis and provide a signal back to the communications module. The communications module may then provide a signal to the control circuitry. The signal ultimately sent to the control circuitry by the communication module may be one indicating the control circuitry should activate the sound emitter or the age verification means. This allows for more complex analysis to be performed off the device, which may render the aerosol provision devices more cost efficient to produce.

Similarly, the age verification means may be able to communicate to a remote database or server or the like. The data obtained by the age verification means may be sent to the remote database or server, analysed and then a signal provided to the control circuitry so the device or system operates accordingly. This communication may occur via a wireless (or the like) communications module.

The term “in response to” is used herein to indicate a second event (such as a signal or change of state of an aerosol provision device) that occurs subsequent to a first event. The second event may occur at a later time, after a predetermined time, or immediately after the first event.

The device and system herein are described as comprising several components that enable several advantages. The components may be disclosed as on-board the device or within the system. The components may be distributed and therefore not necessarily be located on-board the device. The functionality of the device can be provided by communicatively connected components, and such communication may be wireless, enabling such distribution. At which point it is reasonable to foresee that a distributed array of components will operate in the manner of the devices and systems disclosed herein. Components of the device or system may be contained in a further device such as a smartphone, computer, or remote server or the like.

In a particular example, the device disclosed herein may operate with a flavour pod which is replaceable in the device-this may be referred to as a consumable. The flavour may be any of tobacco and glycol and may include extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamon, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof.

When combined with an aerosol generating medium, the aerosol provision device as disclosed herein may be referred to as an aerosol provision system.

Thus there has been described an aerosol provision device for providing an aerosol for inhalation by a user comprising: control circuitry for controlling components of the aerosol provision device; a sound sensor arranged to sense a sound associated with a user of the aerosol provision device and provide a signal to the control circuitry; a signal emitter arranged to emit a signal; and, age verification means for verifying an age of a user, wherein the control circuitry is arranged to i) change an activation state of the signal emitter or ii) or activate the age verification means in response to receiving a signal originating from the sound sensor.

The aerosol provision system may be used in a tobacco industry product, for example a non-combustible aerosol provision system.

In one embodiment, the tobacco industry product comprises one or more components of a non-combustible aerosol provision system, such as a heater and an aerosolizable substrate.

In one embodiment, the aerosol provision system is an electronic cigarette also known as a vaping device.

In one embodiment the electronic cigarette comprises a heater, a power supply capable of supplying power to the heater, an aerosolizable substrate such as a liquid or gel, a housing and optionally a mouthpiece.

In one embodiment the aerosolizable substrate is contained in or on a substrate container. In one embodiment the substrate container is combined with or comprises the heater.

In one embodiment, the tobacco industry product is a heating product which releases one or more compounds by heating, but not burning, a substrate material. The substrate material is an aerosolizable material which may be for example tobacco or other non-tobacco products, which may or may not contain nicotine. In one embodiment, the heating device product is a tobacco heating product.

In one embodiment, the heating product is an electronic device.

In one embodiment, the tobacco heating product comprises a heater, a power supply capable of supplying power to the heater, an aerosolizable substrate such as a solid or gel material.

In one embodiment the heating product is a non-electronic article.

In one embodiment the heating product comprises an aerosolizable substrate such as a solid or gel material, and a heat source which is capable of supplying heat energy to the aerosolizable substrate without any electronic means, such as by burning a combustion material, such as charcoal.

In one embodiment the heating product also comprises a filter capable of filtering the aerosol generated by heating the aerosolizable substrate.

In some embodiments the aerosolizable substrate material may comprise an aerosol or aerosol generating agent or a humectant, such as glycerol, propylene glycol, triacetin or diethylene glycol.

In one embodiment, the tobacco industry product is a hybrid system to generate aerosol by heating, but not burning, a combination of substrate materials. The substrate materials may comprise for example solid, liquid or gel which may or may not contain nicotine. In one embodiment, the hybrid system comprises a liquid or gel substrate and a solid substrate. The solid substrate may be for example tobacco or other non-tobacco products, which may or may not contain nicotine. In one embodiment, the hybrid system comprises a liquid or gel substrate and tobacco.

In order to address various issues and advance the art, the entirety of this disclosure shows by way of illustration various embodiments in which the claimed invention(s) may be practiced and provide for a superior electronic aerosol provision system. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. An aerosol provision device for providing an aerosol for inhalation by a user comprising:
control circuitry for controlling components of the aerosol provision device;
a sound sensor arranged to sense a sound associated with a user of the aerosol provision device and provide a signal to the control circuitry;
a signal emitter arranged to emit a signal; and,
age verification means for verifying an age of a user, wherein the control circuitry is arranged to
i) change an activation state of the signal emitter or
ii) or activate the age verification means
in response to receiving a signal originating from the sound sensor.

2. An aerosol provision device according to claim 1, wherein the control circuitry is arranged to change an activation state of the signal emitter in response to receipt of a signal from the sound sensor associated with an authorised user.

3. An aerosol provision device according to claim 1, wherein the control circuitry is arranged to activate the age verification means in response to receipt of a signal from the sound sensor associated with a non-authorised user.

4. An aerosol provision device according to claim 1, wherein the signal emitter is at least one of: a light emitter; a sound emitter; a haptic element;
and, an emitter module arranged to use at least one of Bluetooth™, Bluetooth Low Energy™, ZigBee™, WiFi™, Wifi Direct™, GSM, 2G, 3G, 4G, 5G, LTE, NFC, or RFID.

5. An aerosol provision device according to claim 1, wherein the age verification means comprises at least one of: a face scanner; a projector scanner; a microphone; a fingerprint scanner; an iris scanner; and, a communication module for communicating with at least one of: a remote database; a remote computing arrangement; an onboard database; and, an onboard computing arrangement.

6. An aerosol provision device according to claim 5, wherein the age verification means is arranged to send an access signal to the control circuitry in response to receipt of a signal associated with a verified user.

7. An aerosol provision device according to claim 5, wherein the age verification means is arranged to send a deny signal to the control circuitry in response to receipt of a signal associated with an unverified user.

8. An aerosol provision device according to claim 1, wherein the sound sensor is arranged to provide a signal to the control circuitry associated with an authorised user in response to detection of at least one of a predetermined vocal pattern and an authorised user's voice.

9. An aerosol provision device according to claim 1, further comprising a communications module arranged to:
receive signals from the sound sensor;
send signals to a server or remote database; and,
send signals received from the server or remote database to the control circuitry.

10. An aerosol provision system for providing an aerosol for inhalation by a user comprising:
an aerosol provision device comprising control circuitry for controlling components of the aerosol provision device;
a sound sensor arranged to sense a sound associated with a user of the aerosol provision device and provide a signal to the control circuitry;
a signal emitter arranged to emit a signal; and,
age verification means for verifying an age of a user, wherein the control circuitry is arranged to
i) change an activation state of the signal emitter or
ii) or activate the age verification means
in response to receiving a signal originating from the sound sensor.

11. An aerosol provision system according to claim 10, wherein the control circuitry is arranged to change an activation state of the signal emitter in response to receipt of a signal from the sound sensor associated with an authorised user.

12. An aerosol provision system according to claim 10, wherein the control circuitry is arranged to activate the age verification means in response to receipt of a signal from the sound sensor associated with a non-authorised user.

13. (canceled)

14. An aerosol provision system according to claim 10, wherein the age verification means comprises at least one of: a face scanner; a projector scanner; a microphone; a fingerprint scanner; an iris scanner; and, a communication module for communicating with at least one of: a remote database; a remote computing arrangement; an onboard database; and, an onboard computing arrangement.

15. An aerosol provision system according to claim 14, wherein the age verification means is arranged to send an access signal to the control circuitry in response to receipt of a signal associated with a verified user.

16. An aerosol provision system according to claim 145, wherein the age verification means is arranged to send a deny signal to the control circuitry in response to receipt of a signal associated with an unverified user.

17. An aerosol provision system according to claim 10, wherein the sound sensor is arranged to provide a signal to the control circuitry associated with an authorised user in response to detection of at least one of a predetermined vocal pattern and an authorised user's voice.

18. An aerosol provision system according to claim 10, wherein at least one of the sound sensor, signal emitter and age verification means is not integral with the aerosol provision device.

19. An aerosol provision system according to claim 10, wherein at least one of the sound sensor, signal emitter and age verification means is a mobile device.

20. An aerosol provision device according to claim 1, further comprising a communications module arranged to:
receive signals from the sound sensor;
send signals to a server or remote database; and,
send signals received from the server or remote database to the control circuitry.

21. A method of providing an aerosol for inhalation by a user, the method comprising:
sensing, by a sound sensor, a sound associated with a user of an aerosol provision device;
providing, by the sound sensor, a signal to control circuitry of the aerosol provision device;
in response to receiving a signal originating from the sound sensor, performing at least one of:
changing, by the control circuitry, an activation state of a signal emitter; and,
activating, by the control circuitry, age verification means.

22. (canceled)
